(19) United States
(12) Patent Application Publication
(10) Pub. No.: US 2007/0079382 A1
(43) Pub. Date: Apr. 5, 2007

(54) Authorizing computer services

(76) Inventors: Ufuk Celikkan, Austin, TX (US); Julianne F. Haugh, Austin, TX (US)

Correspondence Address: INTERNATIONAL CORP (BLF), c/o BIGGERS & OHANIAN, LLP, P.O. BOX 1469, AUSTIN, TX, 78767-1469, US

(21) Appl. No.: 11/227,025

(22) Filed: Sep. 15, 2005

(51) Int. Cl. H04N 7/16

(52) U.S. Cl. 726/26

(57) ABSTRACT

Methods, systems, and products are disclosed for authorizing computer services, the method including receiving in an intermediary node a request for computer services to be performed by a downstream node, the request having passed through at least two upstream nodes prior to receipt by the intermediary node; determining whether the credentials of each of the at least two upstream nodes are valid; passing the request to a downstream node if the credentials of each of the at least two upstream nodes are valid; and deprecating the request if the credentials of at least one of the at least two upstream nodes are invalid.

### BACKGROUND OF THE INVENTION

1. Field of the Invention

The field of the invention is data processing, or, more specifically, methods, systems, and products for authorizing computer services.

2. Description Of Related Art

Many requests for computer services pass through multiple nodes from the initial requester to the ultimate destination service provider. For example, a request for web services may pass from an initial requester through several intermediary web services to an ultimate destination web service that ultimately delivers the web service. Similarly, an email, for example, may pass from a sending client through multiple intermediate mail servers to the ultimate email server of the intended recipient, and from there the email is sent to the email client of the intended recipient. In another example, multiple-node transactions in distributed processing environments, such as business integration applications, may pass through several nodes from initiation until completion.

Security compromises present an ever present danger in such distributed architectures for computer services that are delivered through multi-node transactions where one or more nodes in the transaction rely on the security measures performed by another node. A security compromise in an intermediate server, for example, may result in a downstream server performing unauthorized computer services if the downstream server relies on security measures implemented by the intermediate server or some other upstream node. A compromised email server may, for example, pass spam which travels through multiple email servers until it reach a particular node.

Current mechanisms for verifying the authorization of requests for services in such multi-node transaction are often ineffective and cumbersome. Many services, for example, perform authorizations at the gateway or entry point to a system and trust the results at subsequent downstream nodes. An unauthorized request inserted into the network after this gateway, however, could be constructed to look as though it had arrived through the gateway and had already been authorized.

Another conventional mechanism for verifying the authorization of requests for services in multi-node transactions is carried out through the use of a centralized authority. An example of such a mechanism is Lightweight Third-Party Authentication (‘LTPA’). LTPA provides a mechanism for a user to reuse a login across several servers. The user contacts a central authority which provides the user with a cookie containing an LTPA token. The token gives the user access to login to the several servers.

The use of such conventional centralized mechanisms may, however, produce delays in processing requests because of bottlenecks occurring as a result of the centralized mechanism participating in many different transactions. In addition, the use of a centralized mechanism for verifying the authorization of requests for services may require that the configurations of all possible service providers are known in advance and agree to utilize the centralized mechanism. Further, the use of a centralized mechanism for verifying the authorization of requests for a type of computer services may require that the existing clients, gateways, and servers for the type of computer services be modified to utilize the centralized mechanism.

### SUMMARY OF THE INVENTION

Methods, systems, and products are disclosed for authorizing computer services, the method including receiving in an intermediary node a request for computer services to be performed by a downstream node, the request having passed through at least two upstream nodes prior to receipt by the intermediary node; determining whether the credentials of each of the at least two upstream nodes are valid; passing the request to a downstream node if the credentials of each of the at least two upstream nodes are valid; and deprecating the request if the credentials of at least one of the at least two upstream nodes are invalid.

The foregoing and other objects, features and advantages of the invention will be apparent from the following more particular descriptions of exemplary embodiments of the invention as illustrated in the accompanying drawings wherein like reference numbers generally represent like parts of exemplary embodiments of the invention.

### BRIEF DESCRIPTION OF THE DRAWINGS

FIG. 1 sets forth a network diagram illustrating an exemplary system for authorizing computer services according to embodiments of the present invention.

FIG. 2 sets forth a block diagram illustrating an exemplary system of nodes in a multi-node transaction implementing a request for computer services according to embodiments of the present invention.

FIG. 3 sets forth a block diagram of automated computing machinery comprising an exemplary intermediary node useful in authorizing computer services according to embodiments of the present invention.

FIG. 4 sets forth a flow chart illustrating an exemplary method for authorizing computer services according to embodiments of the present invention.

FIG. 5 sets forth a flow chart illustrating a further exemplary method for authorizing computer services according to embodiments of the present invention.

FIG. 6 sets forth a flow chart illustrating a further exemplary method for authorizing computer services according to embodiments of the present invention.

FIG. 7 sets forth a flow chart illustrating a further exemplary method for authorizing computer services according to embodiments of the present invention.

### DETAILED DESCRIPTION OF EXEMPLARY EMBODIMENTS

### Detailed Description

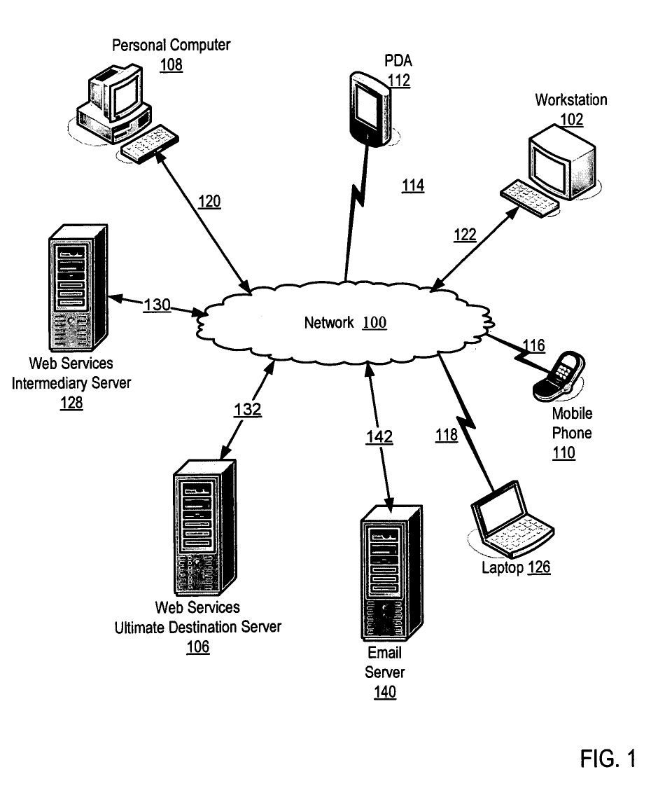

Exemplary methods, systems, and products for authorizing computer services according to embodiments of the present invention are described with reference to the accompanying drawings, beginning with FIG. 1. FIG. 1 sets forth a network diagram illustrating an exemplary system for authorizing computer services according to embodiments of the present invention. The system of FIG. 1 operates generally to authorize computer services according to embodiments of the present invention by receiving in an intermediary node a request for computer services to be performed by a downstream node, the request having passed through at least two upstream nodes prior to receipt by the intermediary node; determining if the credentials of each of the at least two upstream nodes are valid; passing the request to a downstream node if the credentials of each of the at least two upstream nodes are valid; and deprecating the request if the credentials of at least one of the at least two upstream nodes are invalid.

The system of FIG. 1 includes a data communications network. Network (100) provides data communications between initial requesters (102, 112, 108, 126, and 110) of computer services, intermediate nodes (128 and 140), and ultimate destination service providers (106, 140) in multiple-node transactions.

Initial requesters transmit requests for computer services to ultimate destination service providers for processing. A request for computer services is any request for processing to be performed by a computer. Such requests for computer services include a request for web services, a request for email to be passed on to another node, a request that an electronic document be passed to another node, a request for access to a database, a request for access to a file server, and other requests for processing to be performed by a computer as will occur to those of skill in the art. As discussed in more detail below, a request may be sent from the initial requester to the ultimate destination service providers through intermediary nodes which may perform additional processing on the request.

The term “web services” refers to a standardized way of integrating web-based applications. Web services typically provide business services upon request through data communications in standardized formats called bindings. A binding is a specification of a data encoding method and a data communications protocol. The most common binding in use for web services is data encoding in XML according to the SOAP protocol and data communications with HTTP. SOAP (Simple Object Access Protocol) is a request/response messaging protocol that supports passing structured and typed data using XML and extensions.

Web services are often delivered by use of multi-node transactions carried out through the used of web services intermediaries. Web services intermediaries are web services components, typically a server, that lies between a web services requester and a web services ultimate destination server that delivers the web service. Intermediaries operate generally by intercepting a request from a client, optionally providing intermediary services, and then forwarding the request to an ultimate destination web services provider (sometimes referred to as a ‘target service’). Similarly, responses from the web services provider (the target service) are intercepted, optionally operated upon, and then returned to the original requester.

The system of FIG. 1 includes several devices capable of supporting initial requesters. An initial requester of computer services is typically a data communications client, that is, any software capable of carrying out a transaction with an ultimate destination service provider by coupling for data communications to the ultimate destination service provider and transmitting a request to the ultimate destination service provider. Such initial senders are capable of transmitting a request for computer services to an ultimate destination service provider. Examples of devices capable of supporting initial requesters are personal computers, internet-enabled special purpose devices, internet-capable personal data administrators, and others that will occur to those of skill in the art. Such devices are capable of wired and/or wireless couplings to servers supporting transactions carried out through the use of multiple nodes. Devices capable of supporting initial senders in the system of FIG. 1 include:
workstation (102), a computer coupled to network (100) through wireline connection (122);
personal computer (108), coupled to network (100) through wireline connection (120);
personal digital assistant (112), coupled to network (100) through wireless connection (114);
laptop computer (126), coupled to network (100) through wireless connection (118); and
mobile phone (110), coupled to network (100) through wireless connection (116).

The system of FIG. 1 also includes several devices capable of supporting intermediary nodes useful in multi-node transactions. An intermediary node in a multi-node transaction is capable of receiving a request for computer services from another intermediary node or from the initial requester of computer services, optionally processing the request in part, and passing the request on to other intermediary nodes or to an ultimate destination service provider. Devices capable of supporting intermediary nodes in the system of FIG. 1 include:
web services intermediary server (128), a computer coupled to network (100) through wireline connection (130); and
email server (140), a computer coupled to network (100) through wireline connection (142).

In the example of FIG. 1, web services intermediary server (128) is capable of acting as an intermediary node in a transaction for web services by receiving a request for web services from an initial requester or another intermediary web services provider and passing the request on to an ultimate destination web server or another intermediary web services provider. Similarly, in the example of FIG. 1, email server (140) is capable of acting as an intermediary node in email transactions. Email server (140) has installed an operative upon it software to receive email from clients and other email servers and to pass the email on to clients and to other email servers. The inclusion of web services intermediary servers and email servers are for explanation and not for limitation. In fact, intermediary nodes are useful in many contexts and all such intermediary nodes are included within the scope of the present invention.

The system of FIG. 1 includes several devices capable of supporting ultimate destination service providers. Ultimate destination service providers receive requests for computer services over the network (100), process the requests, and may transmit responses over network (100). The system of FIG. 1 includes several devices capable of supporting ultimate destination service providers:
email server (140), coupled to network (100) through wireline connection (142), and
web services ultimate destination server (106), coupled to network (100) through wireline connection (132).

In the exemplary system of FIG. 1, web services ultimate destination server (106) is an ultimate destination service provider for web services. Web services ultimate destination server (106) has installed an operative upon it computer program instructions for providing web services are stored in a computer memory in web services server (106). In the exemplary system of FIG. 1, the email server (140) is also an ultimate destination service provider. Email server (140) of FIG. 1 has installed an operative upon it computer program instructions for receiving email from clients and other email servers and to ultimately making the email available to a requesting email client.

The arrangement of servers and other devices making up the exemplary system illustrated in FIG. 1 are for explanation, not for limitation. Data processing systems useful according to various embodiments of the present invention may include additional servers, routers, other devices, and peer-to-peer architectures, not shown in FIG. 1, as will occur to those of skill in the art. Networks in such data processing systems may support many data communications protocols, including for example TCP (Transmission Control Protocol), IP (Internet Protocol), HTTP (HyperText Transfer Protocol), WAP (Wireless Access Protocol), HDTP (Handheld Device Transport Protocol), and others as will occur to those of skill in the art. Various embodiments of the present invention may be implemented on a variety of hardware platforms in addition to those illustrated in FIG. 1.

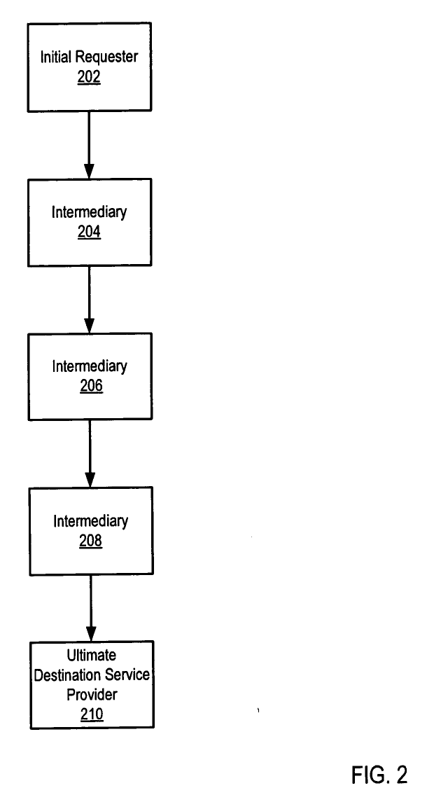

As explained above, a request for computer services may be implemented through a multi-node transaction, with the request being passed from node to node until it reaches an ultimate destination service provider. For further explanation, therefore, FIG. 2 sets forth a block diagram illustrating an exemplary system of nodes in a multi-node transaction implementing a request for computer services according to embodiments of the present invention. A node is typically implemented as an addressable device attached to a computer network. A node may be a computer, a mobile phone, a PDA, or any other device capable of attachment to a computer network that may occur to those of skill in the art. A node that receives a request for computer services before another node in a multi-node transaction is upstream of the other node with respect to a multi-node transaction. A node that receives a request for services after another node in a multi-node transaction is downstream of the node with respect to the multi-node transaction.

Each block in the example of FIG. 2 represents a node. Node (202) is an initial requester, a node that initiates a request for computer services. In the example of FIG. 2, the initial requester (202) sends the request for computer services to intermediary node (204). Intermediary node (204) is a node residing in the transaction between the initial requester (202) and the ultimate destination service provider (210). In the example of FIG. 2, the request for computer services is then passed from intermediary node (204) to another intermediary node (206) and then on to still another intermediary node (208). The intermediary nodes (204, 206, 208) may pass on the request for computer services without additional processing at the intermediary node or may perform additional processing on the requests at the intermediary node prior to passing on the request. The example of FIG. 2 also includes the passing of the request for computer services from intermediary node (208) to ultimate destination service provider (210). Ultimate destination service provider may finish providing the computer services requested by the initial requester (202).

Nodes (204, 206, and 208) in the system of FIG. 2 are improved to authorize computer services according to the present invention. For example, node (208) is improved to authorize computer services according to of the present invention by receiving a request for computer services to be performed by a downstream node (210), the request having passed through at least two upstream nodes (204, 206) prior to receipt by the intermediary node (208); determining if the credentials of each of the at least two upstream nodes (204 and 206) are valid; passing the request to a downstream node (210) if the credentials of each of the at least two upstream nodes (204, 206) are valid; and deprecating the request if the credentials of at least one of the at least two upstream nodes (204 and 206) are invalid. One way of deprecating the request if the credentials of at least one of the at least two upstream nodes (204 and 206) are invalid may be carried out by halting the transmission of the request.

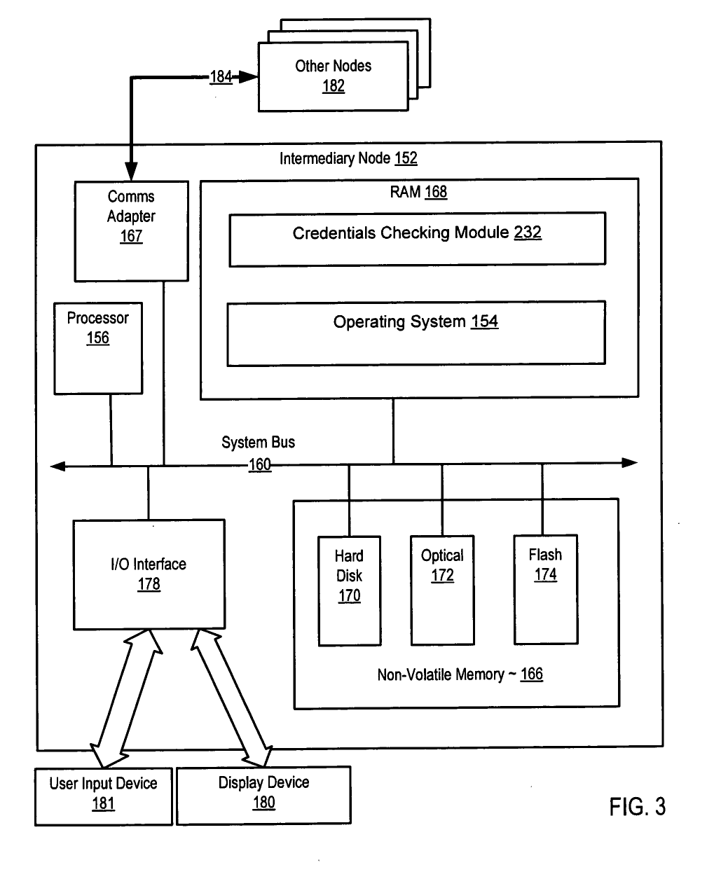

Authorizing computer services in accordance with the present invention is generally implemented with computers, that is, with automated computing machinery. In the system of FIG. 1, for example, all the nodes, servers, and communications devices are implemented to some extent at least as computers. For further explanation, therefore, FIG. 3 sets forth a block diagram of automated computing machinery comprising an exemplary intermediary node (152) useful in authorizing computer services according to embodiments of the present invention. The intermediary node (152) of FIG. 3 includes at least one computer processor (156) or ‘CPU’ as well as random access memory (168) (‘RAM’) which is connected through a system bus (160) to processor (156) and to other components of the computer.

Stored in RAM (168) is a credentials checking module (232), computer program instructions for authorizing computer services according to embodiments of the present invention by receiving a request for computer services to be performed by a downstream node, the request having passed through at least two upstream nodes prior to receipt by the intermediary node; determining if the credentials of each of the at least two upstream nodes are valid; passing the request to a downstream node if the credentials of each of the at least two upstream nodes are valid; and deprecating the request if the credentials of at least one of the at least two upstream nodes are invalid.

Also stored in RAM (168) is an operating system (154). Operating systems useful in computers according to embodiments of the present invention include UNIX™, Linux™, Microsoft NT™, AIX™, IBM's i5/OS™, and others as will occur to those of skill in the art. Operating system (154) and credentials checking module (232) in the example of FIG. 3 are shown in RAM (168), but many components of such software typically are stored in non-volatile memory (166) also.

Intermediary node (152) of FIG. 3 includes non-volatile computer memory (166) coupled through a system bus (160) to processor (156) and to other components of the intermediary node (152). Non-volatile computer memory (166) may be implemented as a hard disk drive (170), optical disk drive (172), electrically erasable programmable read-only memory space (so-called ‘EEPROM’ or ‘Flash’ memory) (174), RAM drives (not shown), or as any other kind of computer memory as will occur to those of skill in the art.

The example intermediary node of FIG. 3 includes one or more input/output interface adapters (178). Input/output interface adapters in computers implement user-oriented input/output through, for example, software drivers and computer hardware for controlling output to display devices (180) such as computer display screens, as well as user input from user input devices (181) such as keyboards and mice.

The exemplary intermediary node (152) of FIG. 3 includes a communications adapter (167) for implementing data communications (184) with other nodes (182), including other intermediary nodes, initial requesters, and ultimate destination service providers. Such data communications may be carried out serially through RS-232 connections, through external buses such as USB, through data communications networks such as IP networks, and in other ways as will occur to those of skill in the art. Communications adapters implement the hardware level of data communications through which one computer sends data communications to another computer, directly or through a network. Examples of communications adapters useful for authorizing computer services according to embodiments of the present invention include modems for wired dial-up communications, Ethernet (IEEE 802.3) adapters for wired network communications, and 802.11b adapters for wireless network communications.

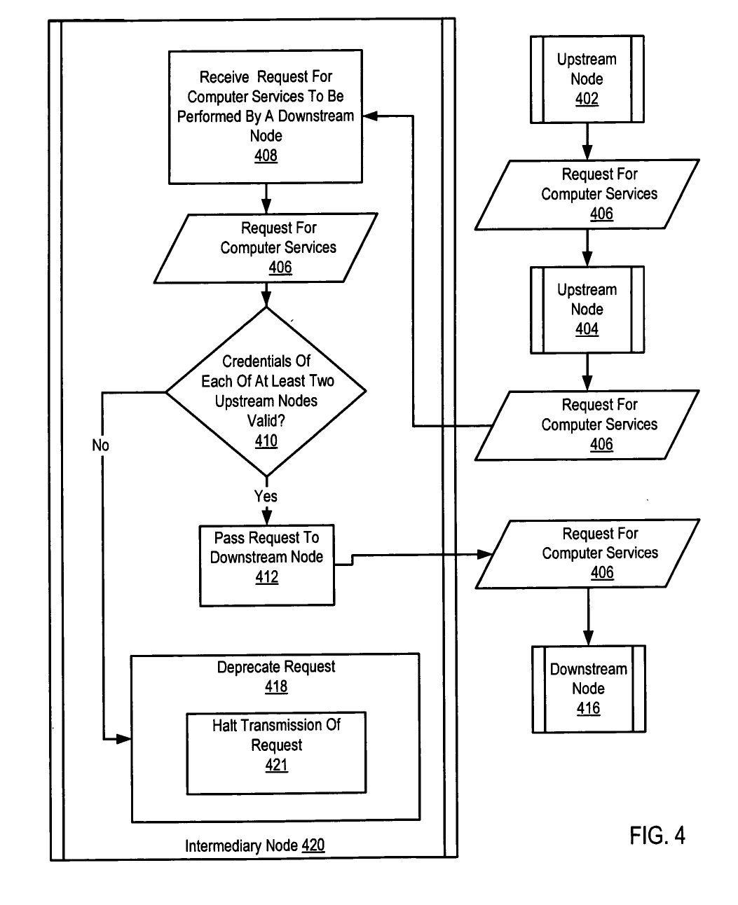

For further explanation, FIG. 4 sets forth a flow chart illustrating an exemplary method for authorizing computer services according to embodiments of the present invention that includes receiving (408) in an intermediary node (420) a request (406) for computer services to be performed by a downstream node (416), the request (406) having passed through at least two upstream nodes (402, 404) prior to receipt by the intermediary node (420). Receiving in an intermediary node a request for computer services to be performed by a downstream node may be carried out by receiving the request according to the protocol by which the request was transmitted. A request for web services, for example, may be sent and received according to the Simple Object Access Protocol (‘SOAP’), a request/response messaging protocol that supports passing structured and typed data using XML and extensions. Email messages, for example, which represent requests for mail services are typically passed from one message transfer agent to another using the Simple Mail Transfer Protocol (‘SMTP’).

In the example of FIG. 4, the request (406) for computer services has passed through two upstream nodes prior to receipt by the intermediary node (420). Passing through an upstream node prior to receipt by the intermediary node (420) may include both receiving a request for computer services and passing the request for computer services to a downstream node, as well as initiating a request for computer services. That is, passing a request through an upstream node may be carried out by an intermediary node as well as an initial requestor in a multi-node transaction.

The method of FIG. 4 also includes determining (410) whether the credentials of each of the at least two upstream nodes (402, 404) are valid. Valid credentials are evidence that a node is entitled to participate as a node in the multi-node transaction invoked by the request for computer services (406) according to security protocols administered in the transaction. That is, valid credentials identify the node as entitled to make a request for computer services, as entitled to pass on the request for computer services, entitled to partially process the request for computer services and so on as will occur to those of skill in the art. Examples of credentials include an identity of the node, a digital signature, the nature of the data communications connection between the intermediary node and one or more upstream nodes, an authorization code, or any other credentials that will occur to those of skill in the art.

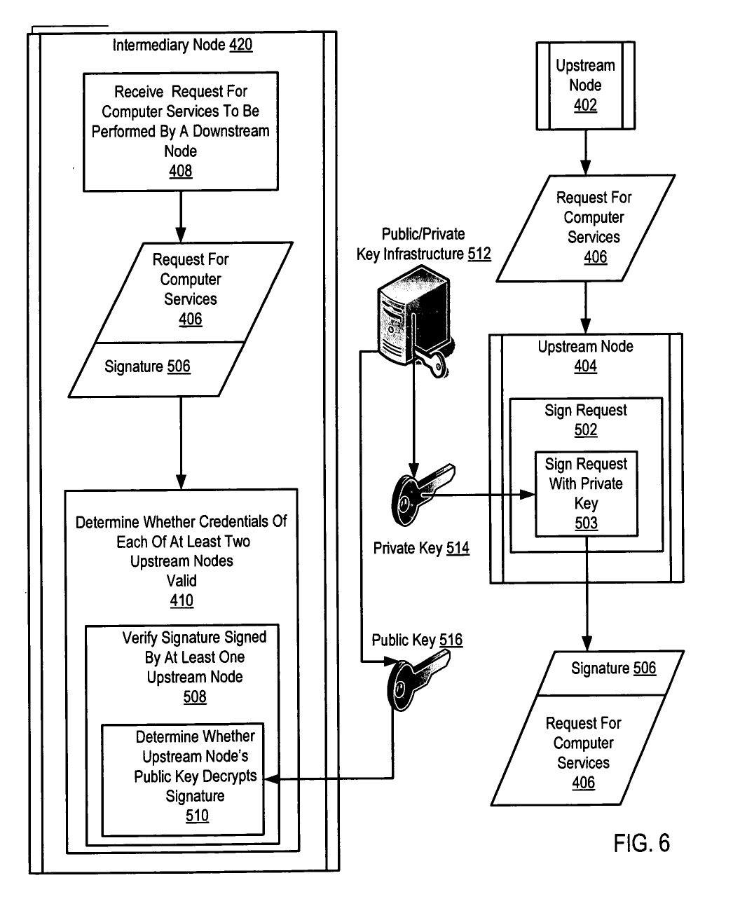

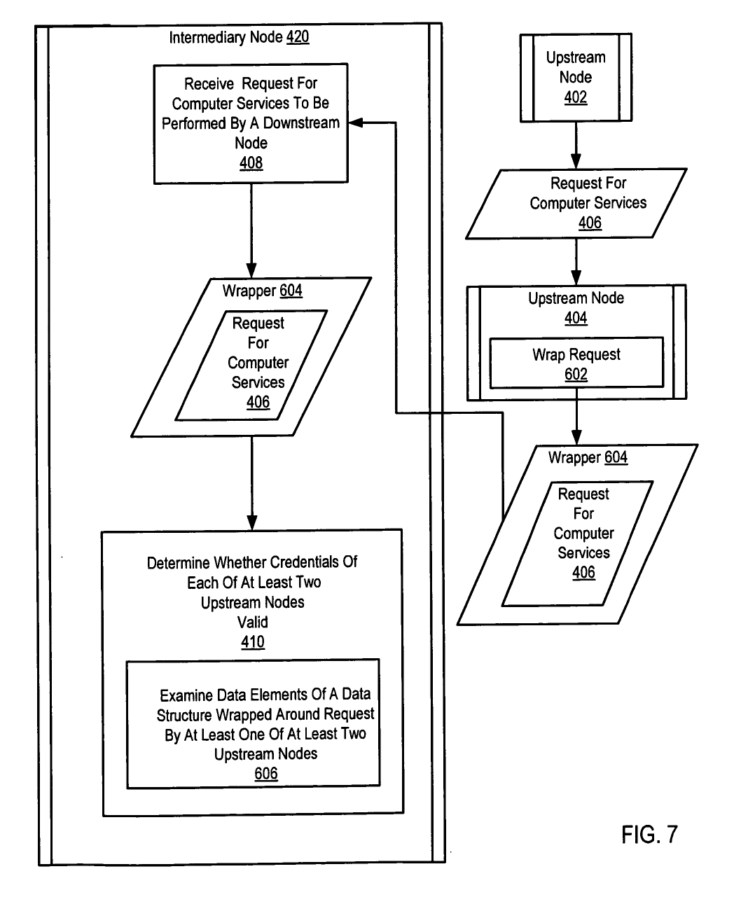

Determining (410) whether the credentials of each of the at least two upstream nodes (402, 404) are valid may be carried out by verifying a signature signed by at least one of the upstream nodes as discussed below with reference to FIG. 6. Determining (410) whether the credentials of each of the at least two upstream nodes (402, 404) are valid may also be carried out by examining data elements of a data structure wrapped around the request by at least one of the at least two upstream nodes (402, 404) as discussed below with reference to FIG. 7. There is also no requirement that an intermediate node or ultimate destination node determine that the credentials of each upstream nodes (402, 404) are valid by use of the same method. That is, the credentials of each node may be evaluated using a node-specific method or may be evaluated using the same method used to determine whether the credentials of other upstream nodes are valid or invalid.

The method of FIG. 4 also includes passing (412) the request (406) to a downstream node (416) if the credentials of each of the at least two upstream nodes are valid. Passing (412) the request (406) to a downstream node (416) if the credentials of each of the at least two upstream nodes are valid may be carried out by transmitting the request to the next node. A request for web services, for example, may be sent and received according to SOAP. Email messages, which represent requests for email services, are typically passed from one message transfer agent to another using SMTP. The downstream node to which the request is passed may be a downstream node addressed by the request, a downstream node looked up in a directory for the type of request, a server to which the intermediary node passes requests of the particular type, or any other downstream node that will occur to those of skill in the art.

Passing (412) the request (406) to a downstream node (416) if the credentials of each of the at least two upstream nodes are valid may include passing the request to a downstream node without additional processing or carrying out services in response to the request. Passing (412) the request (406) to a downstream node (416) if the credentials of each of the at least two upstream nodes are valid may also include passing the request to a downstream node after performing additional processing or carrying out services in response to the request, such as for example decrypting the request, encrypting the request, wrapping and unwrapping the request discussed below, as well as other processing as will occur to those of skill in the art. All such ways of passing are well within the scope of the present invention.

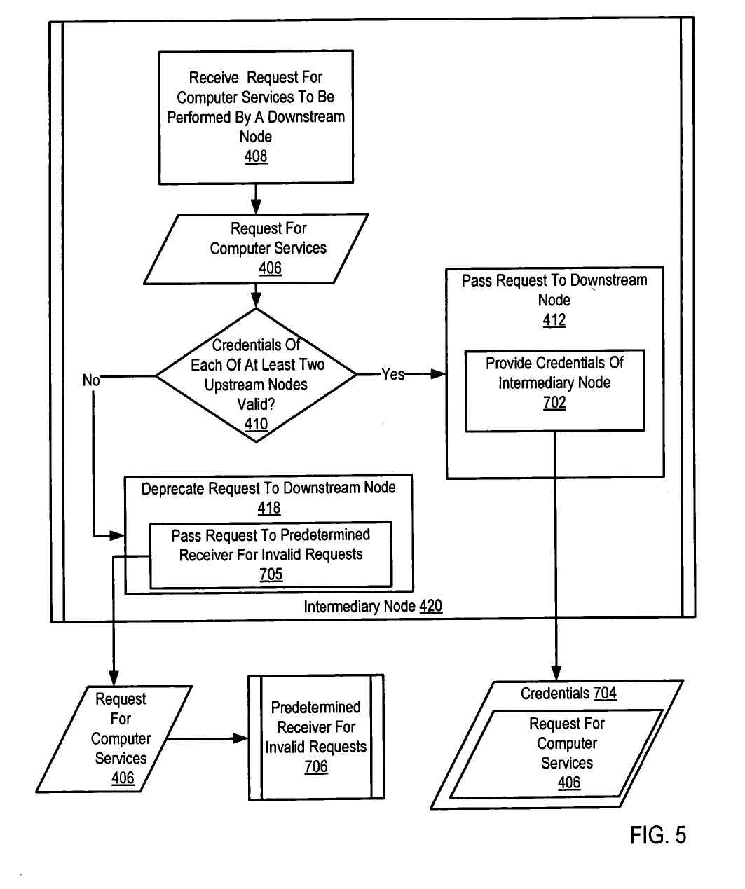

The method of FIG. 4 also includes deprecating (418) the request (406) if the credentials of at least one of the at least two upstream nodes are invalid. Deprecating (418) the request (406) if the credentials of at least one of the at least two upstream nodes are invalid may be carried out by halting (421) transmission of the request (406). Halting transmission of the request may be carried out by discarding the request and not passing the request to a downstream node. Deprecating (418) the request (406) if the credentials of at least one of the at least two upstream nodes are invalid may also be carried out by passing the request to a predetermined receiver for invalid requests as discussed in more detail below with reference to FIG. 5.

Authorizing computer services according to the method of FIG. 4 is useful in providing assurance to service providers that requests for computer services are authorized by at least two previous nodes. Authorizing computer services according to the method of FIG. 4 advantageously reduces the risk of performing services on behalf of unauthorized requestors.

For further explanation, FIG. 5 sets forth a flow chart illustrating a further exemplary method for authorizing computer services according to embodiments of the present invention. The method of FIG. 5 is similar to the method of FIG. 4. That is, the method of FIG. 5 includes receiving (408) in an intermediary node (420) a request (406) for computer services to be performed by a downstream node the request (406) having passed through at least two upstream nodes prior to receipt (408) by the intermediary node (420). The method of FIG. 5 also includes determining (410) whether the credentials of each of the at least two upstream nodes are valid and passing (412) the request (406) to a downstream node if the credentials of each of the at least two upstream nodes are valid.

The method of FIG. 5 differs from the method of FIG. 4, however, in that in the method of FIG. 5, passing (412) the request (406) to a downstream node if the credentials of each of the at least two upstream nodes are valid includes providing (702) with the request (406) credentials (704) of the intermediary node (420). Providing (702) with the request (406) credentials (704) of the intermediary node (420) may be carried out by including with the request credentials of the intermediary node.

The method of FIG. 5 also differs from the method of FIG. 4 in that deprecating (418) the request (406) if the credentials of at least one of the at least two upstream nodes are invalid is carried out by passing (705) the request (406) to a predetermined receiver (706) for invalid requests. A predetermined receiver (706) for invalid requests according to the method of FIG. 5 is typically a service provider designed to receive invalid requests for computer services and providing some service in response to receiving the invalid requests for computer services. Providing such services in response to receiving invalid request may include for example logging in the invalid requests, attempting to validate the requests, maintaining lists of nodes which passed on invalid requests, publishing facts about the invalid requests, seeking remedies against the nodes which passed on invalid requests, or any other service that will occur to those of skill in the art. Passing (705) the request (406) to a predetermined receiver (706) for invalid requests may be carried out by selecting, in dependence upon the invalid request, a particular receiver and passing the invalid request to the particular receiver by use of an appropriate protocol, such as, for example, the protocol which the intermediary node used to receive the request.

Two ways of deprecating (418) the request (406) if the credentials of at least one of the at least two upstream nodes are invalid have been discussed with reference to FIGS. 4 and 5. Halting transmission of the request discussed with reference to FIG. 4 and passing the request to a predetermined receiver for invalid requests discussed with reference to FIG. 5 are provided for explanation and not for limitation. In fact, there are many ways of deprecating (418) the request (406) if the credentials of at least one of the at least two upstream nodes are invalid and all such ways are well within the scope of the present invention. Examples of such ways include passing the request to a downstream node and including with the request a warning message identifying that the credentials of one or more upstream nodes are invalid, passing the request to a downstream node in conjunction with sending a warning to a service provider for receiving such warnings, and in other ways as will occur to those of skill in the art.

For further explanation, FIG. 6 sets forth a flow chart illustrating a further exemplary method for authorizing computer services according to embodiments of the present invention. The method of FIG. 6 is similar to the method of FIG. 4. That is, the method of FIG. 6 includes receiving (408) in an intermediary node (420) a request (406) for computer services to be performed by a downstream node, the request (406) having passed through at least two upstream nodes (402, 404) prior to receipt (408) by the intermediary node (420).

The method of FIG. 6 differs from the method of FIG. 4, however, in that the method of FIG. 6 also includes the signing (502) of the request for computer services (406) by an upstream node (404), thereby creating a signature (506). A signature or digital signature is a transformation of a message that can only be produced by use of certain private information. The creation of the signature proves possession of the private information. Creating a signature is referred to as ‘signing.’

In the example of FIG. 6, signing (502) of the request for computer services (406) by an upstream node (404) is carried out by signing (503) the request with upstream node's private key (514) from a public key/private key infrastructure (512). Signing a request with a private key may be carried out by hashing the request and encrypting the hash with a private key in a public key/private key infrastructure. A private key is private information typically known only to the possessor of the private key.

The method of FIG. 6 is similar to the method of FIG. 4 in that the method of FIG. 6 includes determining (410) whether the credentials of each of the at least two upstream nodes (402, 404) are valid. In the method of FIG. 6, however, determining (410) whether the credentials of each of the at least two upstream nodes (402, 404) are valid further includes verifying (508) a signature (506) signed (502) by at least one of the upstream nodes (404). In the method of FIG. 6, verifying (508) a signature (506) signed (502) by at least one of the upstream nodes (404) includes determining (510) whether the upstream node's public key (516) decrypts the signature (506). Determining whether the upstream node's public key (516) decrypts the signature (506) may be carried out by, for example, by attempting to decrypt the signature with the upstream node's public key (516), thereby yielding a purported hash of the request. The purported hash so produced may be compared with a hash of the request carried out by the intermediary node (420). The equality of the two hashes confirms that the upstream node's public key (516) decrypts the signature. The equality of the two hashes further determines that the signature is valid.

Decrypting the signature (506) with the upstream node's public key (516) validates the signature (506) because the signature (506) can only have been produced by the upstream node (404) using the upstream node's private key. In general, the private key corresponding to a given public key is the unique key capable of encrypting a message decrypted by the given public key. The equality of the two hashes demonstrates that only the upstream node's private key (516) was capable of encrypting the hash to produce the signature and thereby shows that the upstream node (404), as the sole possessor of the upstream node'private key, is the author of the signature (506). The process of validating the signature therefore also typically authenticates the identity of the upstream node (404) which signed the request.

The authentication process also provides assurance of the integrity of the request, that is, that the request has been received without alteration. Had the contents of the request been altered in transmission, the hash of the received request would not equal the hash of the sent request performed by the upstream node (404) in producing the signature (506).

The method of FIG. 6 advantageously operates in a decentralized manner. Each intermediary node may verify at least two previous nodes in a multiple-node transaction. In cases where a node's credentials consist of signatures, for example, an intermediary node may verify the signatures by carrying out the processes of decryption of signatures and comparison of hashes. While the intermediary node (420) may consult a certification authority to verify that the owner of a key is indeed the entity which claims to own the key, such is typically brief, requiring little action on the part of the certification authority, and therefore typically does not produce bottlenecks experienced by other centralized authentication services.

For further explanation, FIG. 7 sets forth a flow chart illustrating a further exemplary method for authorizing computer services according to embodiments of the present invention. The method of FIG. 7 is similar to the method of FIG. 4 in that the method of FIG. 7 includes receiving (408) in an intermediary node (420) a request (406) for computer services to be performed by a downstream node, the request (406) having passed through at least two upstream nodes (402, 404) prior to receipt (408) by the intermediary node (420). The method of FIG. 7 differs from the method of FIG. 4, however, in that the method of FIG. 7 includes wrapping (602) the request for computer services by an upstream node (404), thereby producing a wrapper (604) around the request (406). Wrapping (602) a request (408) may be carried out by creating a compound data structure which includes the request (406) and additional data added as a component to create a wrapper (604). Such a compound data structure may, for example, include a header describing the compound data structure and indicating the location of the additional data in the compound data structure. A node may, for example, wrap a request for computer services to create a compound data structure which includes the node's signature as additional data, as well as the request.

The method of FIG. 7 is also similar to the method of FIG. 4 in that the method of FIG. 7 includes determining (410) whether the credentials of each of the at least two upstream nodes (402, 404) are valid. The method of FIG. 7 differs from the method of FIG. 4, however, in that determining (410) whether the credentials of each of the at least two upstream nodes (402, 404) are valid includes examining (606) data elements of a wrapper (604) wrapped around the request by at least one of the at least two upstream nodes. Examining (606) data elements of a wrapper (604) wrapped (602) around the request by at least one of the at least two upstream nodes may be carried out by examining the components of the data structure designated as credentials for determining the validity of the request. Consider for example, a wrap request (406) containing header elements describing the components of the wrapper (604) and identifying the location of data elements designated as credentials for determining the validity of the request.

Examining (606) data elements of a wrapper (604) wrapped around the request by at least one of the at least two upstream nodes according to the method of FIG. 7 may alternatively be carried out according to a standard protocol by examining the components of the compound data structure in accordance with the protocol. A SOAP request, for example, is an example of a wrapped data structure. An envelope of the SOAP request contains a header section and a body element. The body element contains the substance of the SOAP request. The body element is delimited by the start element “<body>” and the end element “</body >.” The body element may be examined by examining the text between the start and end elements of the body. In such an example, data elements designated as credentials for the soap request may be included within the body of the SOAP request.

Examining (606) data elements of a wrapper (604) wrapped around the request by at least one of the at least two upstream nodes according to the method of FIG. 7, may be carried out without “unwrapping” the wrapped data structure. That is, data elements of a wrapped request may, in many cases, be accessed without additional steps for unwrapping the request. Alternatively, examining (606) data elements (406) of a data structure (604) wrapped (602) around the request by at least one of the at least two upstream nodes according to the method of FIG. 7, may be carried out by unwrapping the wrapped data structure. That is, in some cases a wrapped request requires additional processing steps to examine the data elements designated as credentials for the request.

Authorizing computer services according to embodiments of the present invention advantageously enables authorizing requests for computer services without the modification of the protocols used for passing and processing the requests. Some protocols, for example, allow for the inclusion of additional information which is not used by the protocol. Techniques exist, for example, for adding information to email messages outside of the requirements of SMTP. As a result, the present invention can be practiced without a need to modify the existing systems, such as for example, those that support SMTP. In protocols which do not provide mechanisms for the inclusion of additional information not used by the protocols with requests for computer services, the wrapping and unwrapping of requests for computer services may be used advantageously as a means for including credentials with requests for computer services while avoiding the modification of the underlying protocols used for processing the requests.

Two ways of determining (410) whether the credentials of each of the at least two upstream nodes (402, 404) are valid have been discussed above with reference to FIGS. 6 and 7. Verifying a signature signed by at least one of the upstream nodes discussed below with reference to FIG. 6 and examining data elements of a data structure wrapped around the request by at least one of the at least two upstream nodes discussed below with reference to FIG. 7 are included for explanation and not for limitation. In fact, determining whether the credentials of each of the at least two upstream nodes (402, 404) are valid may also be carried out in many ways and all such ways are well within the scope of the present invention. Additional ways of determining (410) whether the credentials of each of the at least two upstream nodes (402, 404) are valid include determining that the data communications connection between the upstream nodes and the intermediary node meet minimum established security standards, such as a data communications connection within a secure virtual private network or LAN or a hardwired data communications connection; receiving as credentials for the upstream nodes authorization codes, examining the authorization codes, and determining that the authorization codes are proper for the current multiple-node transaction; as well as other ways that will occur to those of skill in the art.

Authorizing computer services according to embodiments of the present invention may usefully aid in reducing the delivery of unauthorized services. Consider for further example the problem of email spam. Authorizing computer services according to embodiments of the present invention provide a vehicle for email servers to add credentials to transmitted emails such that intermediate email servers or ultimate destination email servers may determine whether the credentials of at least two upstream nodes are valid. Upon identifying invalid credentials for nodes, intermediary email servers or ultimate destination email servers may for example usefully:
maintain lists of actual identified spammers;
maintain a list of suspected spammers; and
refuse to pass emails identified as having passed through nodes found to be on a list of identified spammers or suspected spammers.

Exemplary embodiments of the present invention are described largely in the context of a fully functional computer system for authorizing computer services. Readers of skill in the art will recognize, however, that the present invention also may be embodied in a computer program product disposed on signal bearing media for use with any suitable data processing system. Such signal bearing media may be transmission media or recordable media for machine-readable information, including magnetic media, optical media, or other suitable media. Examples of recordable media include magnetic disks in hard drives or diskettes, compact disks for optical drives, magnetic tape, and others as will occur to those of skill in the art. Examples of transmission media include telephone networks for voice communications and digital data communications networks such as, for example, Ethernet™ and networks that communicate with the Internet Protocol and the World Wide Web. Persons skilled in the art will immediately recognize that any computer system having suitable programming means will be capable of executing the steps of the method of the invention as embodied in a program product. Persons skilled in the art will recognize immediately that, although some of the exemplary embodiments described in this specification are oriented to software installed and executing on computer hardware, nevertheless, alternative embodiments implemented as firmware or as hardware are well within the scope of the present invention.

It will be understood from the foregoing description that modifications and changes may be made in various embodiments of the present invention without departing from its true spirit. The descriptions in this specification are for purposes of illustration only and are not to be construed in a limiting sense. The scope of the present invention is limited only by the language of the following claims.

What is claimed is:

1. A method for authorizing computer services, the method comprising:
receiving in an intermediary node a request for computer services to be performed by a downstream node, the request having passed through at least two upstream nodes prior to receipt by the intermediary node;
determining whether the credentials of each of the at least two upstream nodes are valid;
passing the request to a downstream node if the credentials of each of the at least two upstream nodes are valid; and
deprecating the request if the credentials of at least one of the at least two upstream nodes are invalid.

2. The method of claim 1 wherein determining if the credentials of each of the at least two upstream nodes are valid further comprises determining, by the intermediate node, if the credentials of each of the at least two upstream nodes are valid.

3. The method of claim 1 wherein determining whether the credentials of each of the at least two upstream nodes are valid further comprises verifying a signature signed by at least one of the upstream nodes.

4. The method of claim 3 wherein verifying a signature signed by at least one of the upstream nodes further comprises determining whether the upstream node's public key decrypts the signature.

5. The method of claim 1, wherein determining whether the credentials of each of the at least two upstream nodes are valid further comprises examining data elements of a data structure wrapped around the request by at least one of the at least two upstream nodes.

6. The method of claim 1, wherein deprecating the request if the credentials of at least one of the at least two upstream nodes are invalid further comprises halting the transmission of the request.

7. The method of claim 1, wherein deprecating the request if the credentials of at least one of the at least two upstream nodes are invalid further comprises passing the request to a predetermined receiver for invalid requests.

8. The method of claim 1, wherein passing the request to a downstream node if the credentials of each of the at least two upstream nodes are valid further comprises providing with the request credentials of the intermediary node.

9. A system for authorizing computer services, the system comprising:
a computer processor;
a computer memory operatively coupled to the computer processor, the computer memory having disposed within it computer program instructions capable of:
receiving in an intermediary node a request for computer services to be performed by a downstream node, the request having passed through at least two upstream nodes prior to receipt by the intermediary node;
determining whether the credentials of each of the at least two upstream nodes are valid;
passing the request to a downstream node if the credentials of each of the at least two upstream nodes are valid; and
deprecating the request if the credentials of at least one of the at least two upstream nodes are invalid.

10. The system of claim 9 wherein the computer memory also has disposed within it computer program instructions capable of verifying a signature signed by at least one of the upstream nodes.

11. The system of claim 10 wherein the computer memory also has disposed within it computer program instructions capable of determining whether the upstream node's public key decrypts the signature.

12. The system of claim 9, wherein the computer memory also has disposed within it computer program instructions capable of examining data elements of a data structure wrapped around the request by at least one of the at least two upstream nodes.

13. The system of claim 9, wherein the computer memory also has disposed within it computer program instructions capable of halting the transmission of the request.

14. The system of claim 9, wherein the computer memory also has disposed within it computer program instructions capable of passing the request to a predetermined receiver for invalid requests.

15. A computer program product for authorizing computer services, the computer program product embodied on a computer-readable medium, the computer program product comprising:
computer program instructions for receiving in an intermediary node a request for computer services to be performed by a downstream node, the request having passed through at least two upstream nodes prior to receipt by the intermediary node;
computer program instructions for determining whether the credentials of each of the at least two upstream nodes are valid;
computer program instructions for passing the request to a downstream node if the credentials of each of the at least two upstream nodes are valid; and
computer program instructions for deprecating the request if the credentials of at least one of the at least two upstream nodes are invalid.

16. The computer program product of claim 15 wherein the signal bearing medium comprises a recordable medium.

17. The computer program product of claim 15 wherein the signal bearing medium comprises a transmission medium.

18. The computer program product of claim 15 wherein computer program instructions for verifying a signature signed by at least one of the upstream nodes further comprises computer program instructions for determining whether the upstream node's public key decrypts the signature.

19. The computer program product of claim 15, wherein computer program instructions for determining whether the credentials of each of the at least two upstream nodes are valid further comprises computer program instructions for examining data elements of a data structure wrapped around the request by at least one of the at least two upstream nodes.

20. The computer program product of claim 15, wherein computer program instructions for deprecating the request if the credentials of at least one of the at least two upstream nodes are invalid further comprises computer program instructions for halting the transmission of the request.
